(19) United States
(12) Patent Application Publication
(10) Pub. No.: US 2024/0257128 A1
(43) Pub. Date: Aug. 1, 2024

(54) AVAILABILITY STATUS FOR REAL-TIME PAYMENT NETWORKS

(71) Applicant: American Express Travel Related Services Company, Inc., New York, NY (US)

(72) Inventors: Tristan M. Fuentes, Mesa, AZ (US); Benjamin J. Cane, Phoenix, AZ (US); Abhinav Aryendra, Phoenix, AZ (US)

(21) Appl. No.: 18/159,738

(22) Filed: Jan. 26, 2023

(51) Int. Cl. G06Q 20/40

(52) U.S. Cl. CPC G06Q 20/4014

(57) ABSTRACT

Disclosed are various embodiments for determining availability of payment entities existing on various payment networks. In one non-limiting example, a computing device is configured to transmit a query to a first network hub for a status of a participant system. The participant system is connected to the first network hub. The computing device is configured to determine a participant status for the participant system based at least in part on a query response from the first network hub. A participant status cache is updated based at least in part on the participant status. The participant status is propagated to a second network hub connected to the first supernetwork instance. The participant status is propagated to a second supernetwork instance connected to the first supernetwork instance.

### BACKGROUND

Financial institutions use real-time payment networks to send funds to other participating financial institutions in real-time or near real-time. Financial institutions may also be members of other types of payment networks. Moreover, financial institutions may be members of multiple payment networks to offer multiple payment options to customers and to increase the ability of the financial institution to make electronic payments to other financial institutions.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting a real-time payment network according to various embodiments of the present disclosure.

FIG. 2 is a drawing of a supernetwork according to various embodiments of the present disclosure.

FIG. 3 is a flowchart illustrating one example of functionality implemented as portions of an application executed in a computing environment in the super-network of FIG. 2 according to various embodiments of the present disclosure.

FIG. 4 is a flowchart illustrating one example of functionality implemented as portions of an application executed in a computing environment in the super-network of FIG. 2 according to various embodiments of the present disclosure.

FIG. 5 is a flowchart illustrating one example of functionality implemented as portions of an application executed in a computing environment in the super-network of FIG. 2 according to various embodiments of the present disclosure.

FIG. 6 is a flowchart illustrating one example of functionality implemented as portions of an application executed in a computing environment in the super-network of FIG. 2 according to various embodiments of the present disclosure.

FIG. 7 is a block diagram of a status payload according to various embodiments of the present disclosure.

FIG. 8 is a flowchart illustrating one example of functionality implemented as portions of an application executed in a computing environment in the super-network of FIG. 2 according to various embodiments of the present disclosure.

FIG. 9 is a flowchart illustrating one example of functionality implemented as portions of an application executed in a computing environment in the super-network of FIG. 2 according to various embodiments of the present disclosure.

FIG. 10 is a flowchart illustrating one example of functionality implemented as portions of an application executed in a computing environment in the super-network of FIG. 2 according to various embodiments of the present disclosure.

FIG. 11 is a flowchart illustrating one example of functionality implemented as portions of an application executed in a computing environment in a real-time payment network of FIG. 1 according to various embodiments of the present disclosure.

### DETAILED DESCRIPTION

Disclosed are various approaches for determining the availability status of payment entities on different real-time payment networks. Financial institutions are often members of real-time payment (RTP) networks in order to allow real-time payments between the financial institutions. Generally, as long as two financial institutions are members of the same RTP network, they can make real-time payments with each other.

However, there are multiple RTP networks currently available. If two financial institutions are not members of the same RTP network, then they cannot make a real-time payment with each other. This can happen when multiple RTP networks are available within the same jurisdiction (e.g., FedNow and THE CLEARING HOUSE in the United States) or when financial institutions are located in different jurisdictions that provide different RTP networks due to regulatory differences and oversight. Accordingly, the various embodiments of the present disclosure solve the problem that occurs when a first financial institution that is a member of a real-time payment network wants to make a real-time payment to a second financial institution that is not a member of the real-time payment network.

Additionally, in the context of real-time payments, transactions can be cleared within minutes, if not in seconds. However, in order for a source financial institution on a first real-time payment network to successfully make a payment in real-time, the source financial institution needs to know if the destination financial institution is available and accepting payments while on a different RTP network. Further, the source financial institution may need to know the real-time payment capabilities of the destination financial institutions. Accordingly, the embodiments of the present disclosure solve the technical problems related to providing a source financial institution with a current status and/or a real-time payment capability of a destination financial institution that is connected to a different real-time payment network.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

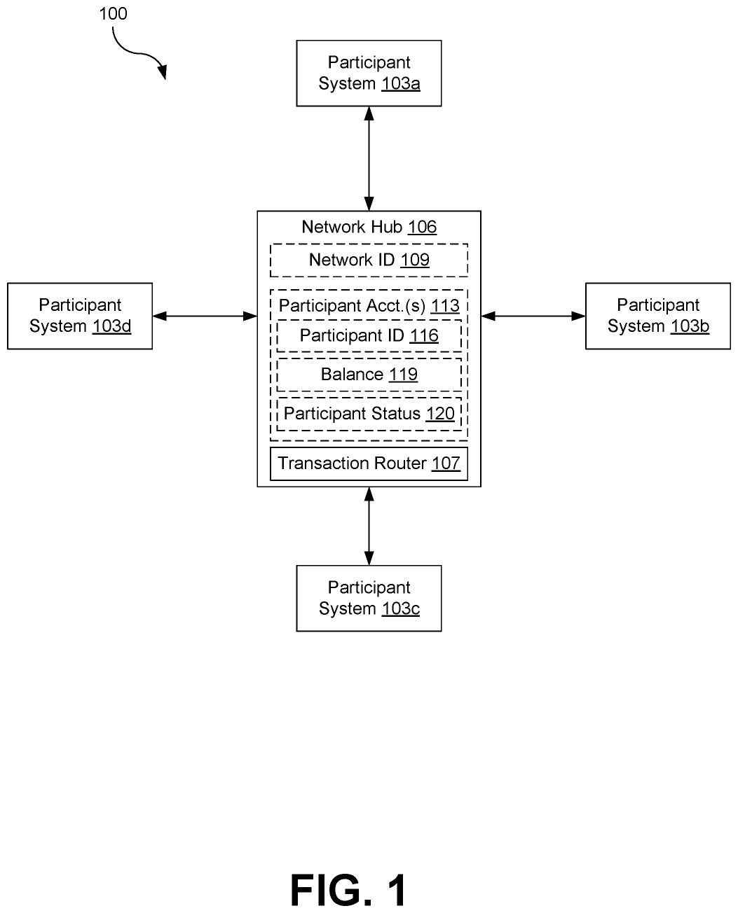

FIG. 1 is a schematic block diagram depicting an example of a real-time payment (RTP) network 100. An RTP network 100 is a payment rail or a payment network that allows member institutions to make payments to each other with immediate availability at any time, in contrast to other payment rails or networks where payments may take several days to process and/or may only be made or processed on specific days or hours (e.g., only on business days and/or only during business hours). Examples of RTP networks 100 in the United States are THE CLEARING HOUSE RTP network offered by The Clearing House and the FEDNOW RTP network offered by the Federal Reserve. Other RTP networks 100 may be available in other jurisdictions.

The RTP network 100 can have a number of components, such as one or more participant systems 103 (e.g., participant system 103a, participant system 103b, participant system 103c, participant system 103d, etc.) and a network hub 106. Participant systems 103 represent systems owned or operated by members of the RTP network 100, such as banks or other financial institutions that use the RTP network 100 to send and receive payments in real time. The network hub 106 can represent one or more computing systems and software services that receive and reconcile payment requests from participant systems 103.

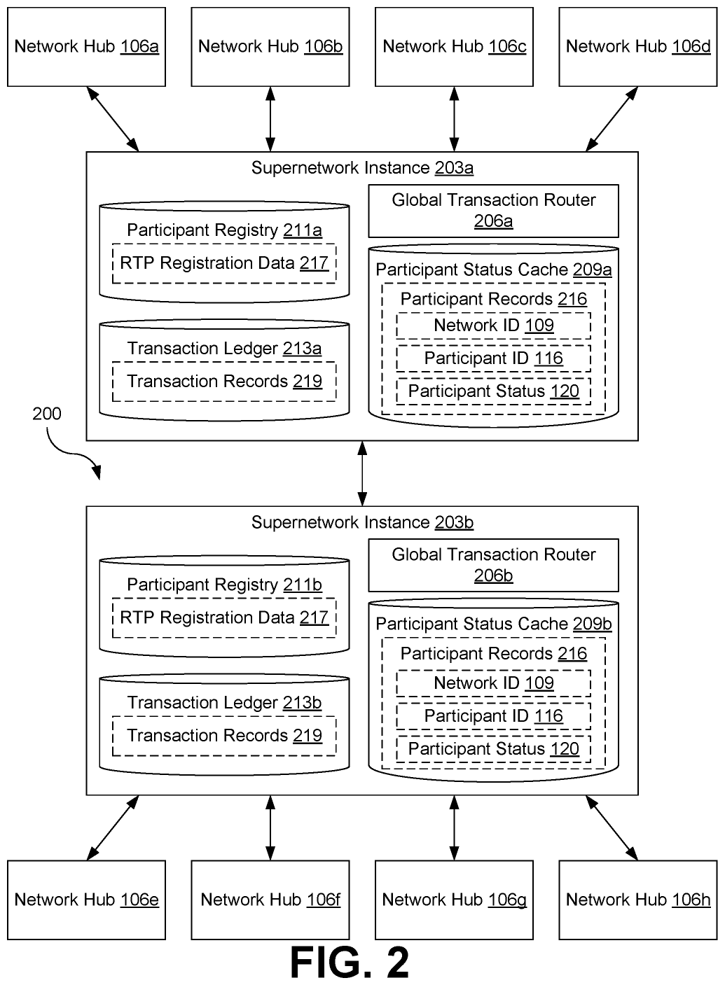

The network hub 106 can include a transaction router 107 and various data. The transaction router 107 can be executed to facilitate routing payment requests from participant systems 103 to different RTP networks 100. The transaction router 107 can manage various data related to the payment requests. Accordingly, the network hub 106 can store various data to allow it to facilitate payments from one network participant system 103 to another network participant system 103, as well as route payments from a network participant system 103 of the RTP network 100 to another network participant system 103 of another RTP network 100 using a supernetwork 200 (FIG. 2). This data could include a network identifier 109 and one or more participant accounts 113.

The network identifier 109 can represent any identifier that uniquely identifies an RTP network 100 with respect to another RTP network 100. The network identifier 109 can be used by the supernetwork 200 to identify or distinguish between individual RTP networks 100 when routing payments between RTP networks 100.

Participant accounts 113 can be used by the network hub 106 to track the amount of funds each participant system 103 has on deposit with the RTP network 100. Accordingly, each participant system 103 of a participant can be associated with a participant account 113. A participant account 113 can include information such as a participant identifier 116, a balance 119, and a participant status 120. The participant identifier 116 can be any identifier that uniquely identifies a participant system 103, and therefore a participant, with respect to another participant system 103, and therefore another participant. The balance 119 can represent the amount of funds available in the participant account 113 to a respective participant. When a payment request is sent by a first participant system 103, the amount of the balance 119 in the participant account 113 associated with the first participant system 103 is reduced by the amount specified in the payment request. Meanwhile, the amount of the balance 119 in the participant account 113 of the second recipient participant system 103 is increased by the amount specified in the payment request.

The participant status 120 can represent the availability of a participant system 103 to receive a payment request. In some examples, the participant status 120 can reflect the status of a participant system 103 on another RTP network 100. Since participant systems 103 can be connected to different RTP networks 100, the participant status 120 of a participant system 103 can be identified before a payment request is transmitted to another RTP network 100. For example, the participant status 120 can indicate if the participant system 103 is signed on to a RTP network 100, is signed off a RTP network 100, is physically connected to a RTP network 100, is physically disconnected to a RTP network 100, has no response from the participant system 103, and other suitable statuses for the participant system 103. If a participant system 103 is available, the participant status 120 can include data relating one or payment features or capabilities of the participant system 103. For example, a payment feature or capability can include a network speed, a payment transfer cost, a supported payment type, a reliability metric, and other suitable features. The participant status 120 can also include a data center location, a previous status, a time stamp for the participant status, an event identifier, and other suitable data elements.

Moreover, an operator of the supernetwork 200 can also maintain a participant account 113 with the RTP network 100. The participant account 113 of the supernetwork 200 can be used by the supernetwork 200 to facilitate payments between members of the RTP network 100 and members of other RTP networks 100, as described in further detail later.

Each supernetwork instance 203 can include a number of components. For example, a supernetwork instance 203 can include a global transaction router 206, a participant status cache 209, a participant registry 211, and a transaction ledger 213. The global transaction router 206 can be executed to route payment requests between network hubs 106 of different RTP networks 100 connected to a supernetwork instance 203.

FIG. 2 is a schematic block diagram depicting an example of a supernetwork 200 according to various embodiments of the present disclosure. The supernetwork 200 can be implemented to route payments between different RTP networks 100 (FIG. 2), thereby allowing a participant of a first RTP network 100 to make a real-time payment to a participant of a separate, second RTP network 100. Accordingly, the supernetwork 200 can include one or more supernetwork instances 203, such as supernetwork instance 203a and supernetwork instance 203b, that form a peer-to-peer network with each other. Each supernetwork instance 203 can be in data communication with one or more network hubs 106, such as network hubs 106a, 106b, 106c, 106d, 106e, 106f, 106g, and 106h.

Each supernetwork instance 203 can include a number of components. For example, a supernetwork instance 203 can include a global transaction router 206, a participant status cache 209, a participant registry 211, and a transaction ledger 213. The global transaction router 206 can be executed to route payment requests between network hubs 106 of different RTP networks 100 connected to a supernetwork instance 203.

The participant status cache 209, participant registry 211, and the transaction ledger 213 are all representative of data stores and associated with the operation of the various applications or functional entities of the various embodiments of the present disclosure. The participant status cache 209, participant registry 211, and the transaction ledger 213 can be implemented as relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. In many instances of the present disclosure, participant status cache 209, participant registry 211, and the transaction ledger 213 can be implemented as distributed, eventually consistent data stores in order to synchronize the data across multiple supernetwork instances 203. The participant status cache 209 can include one or more participant records 216. The participant registry 211 can store RTP registration data 217. Meanwhile the transaction ledger 213 can include one or more transaction records 219. Other data can also be stored in the participant status cache 209, participant registry 211, or the transaction ledger 213 as desired by various embodiments of the present disclosure. Moreover, while depicted separately, the data stored in the participant status cache 209, participant registry 211, and the transaction ledger 213 can be combined into one or more data stores in some implementations.

A participant record 216 represents a record of a participant system 103 that is a member of an RTP network 100. Each participant record 216 can include the network identifier 109 of the RTP network 100 that the participant system 103 is a member of, as well as the participant identifier 116 of the participant system 103 in the RTP network 100. If a participant or participant system 103 is a member of or a participant in multiple RTP networks 100, then the participant or participant system 103 could be associated with multiple participant records 216.

Additionally, the participant record 216 can include a participant status 120 associated with each participant system 103 in each RTP network 100 with a network hub 106 connected to a supernetwork instance 203. The global transaction router 206 can update the participant status 120 based at least in part on data received from individual network hubs 106 and/or other supernetwork instances 203. In some examples, the participant status cache 209 can have a respective participant record 216 for each participant system 103 connected to network hubs 106a-d and associated with the supernetwork instance 203a. Additionally, the participant status cache 209 can have a respective participant record 216 for each participant system 103 connected to network hubs 106e-h and associated with the supernetwork instance 203b. Each participant record 216 can maintain a participant status 120 for its associated participant system 103. Other information can also be included in a participant record 216 as desired for particular implementations of the present disclosure.

RTP registration data 217 includes information about individual RTP networks 100 with a network hub 106 connected to a supernetwork instance 203 of the supernetwork. RTP registration data 217 can include a list of network hubs 106 or RTP networks 100 and the individual supernetwork instances 203 that the network hubs 106 are connect to or in data communication with. For example, RTP registration data 217 could map a network identifier 109 for an RTP network 100 to a particular supernetwork instance 203 (e.g., by using an instance identifier of the supernetwork instance 203). Other information regarding individual RTP networks 100 could also be stored in the RTP registration data 217 as desired for individual implementations of the present disclosure.

A transaction record 219 can represent a record of a transaction made between participants of two different RTP networks 100 within the supernetwork 200. Information stored in the transaction record 219 can include the participant identifier 116 and network identifier 109 of the payer, the participant identifier 116 and network identifier 109 of the payee, the amount of the transaction, as well as any other information that may be relevant to a particular embodiment of the present disclosure.

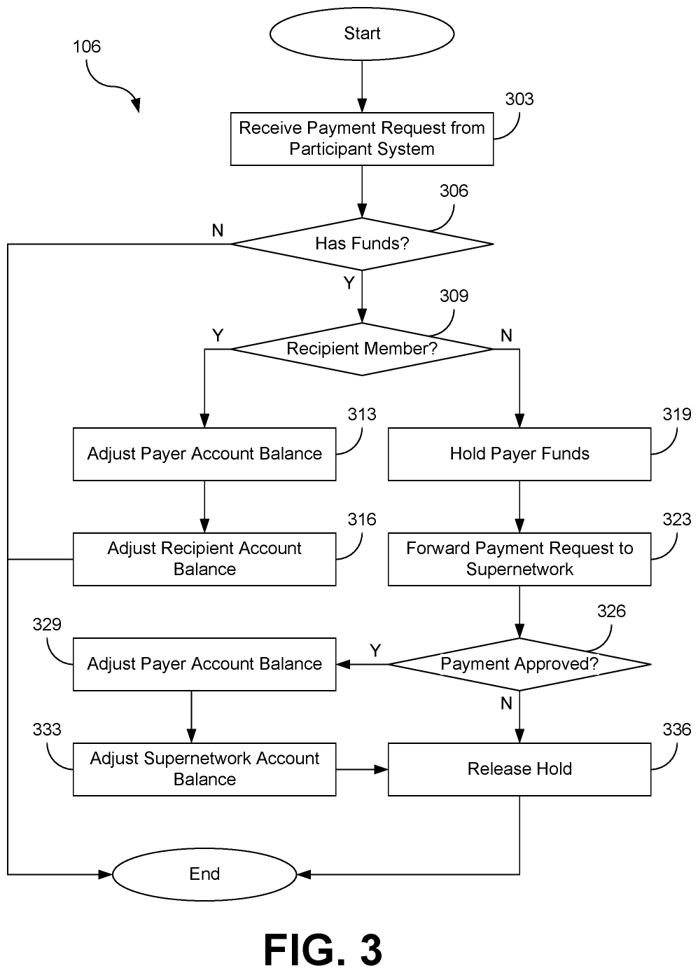

Next, a general description of the operation of the various components of the supernetwork 200 is provided. Although the following description provides merely an example of the operation of the supernetwork 200, and the interactions between individual components, other interactions and operations can also be performed by the various embodiments of the present disclosure. More detailed description of the operation of individual components is illustrated in the flowcharts of FIGS. 3-6.

To begin, a network hub 106 of an RTP network 100 can be configured to connect to a supernetwork instance 203 of the supernetwork 200. As part of the connection process, the network hub 106 can be configured to send and receive messages to the supernetwork instance 203 using a supernetwork compliant message protocol. The network hub 106 could also be configured to translate payment messages from the format of the RTP network 100 serviced by the network hub 106 to the supernetwork compliant message protocol, and vice versa. Moreover, during the registration or first connection of the network hub 106 of the RTP network 100 with the supernetwork instance 203, the RTP registration data 217 for the RTP network 100 could be saved to the participant registry 211. For example, the network identifier 109 for the RTP network 100 could be saved in association with an instance identifier of the supernetwork instance 203 that the network hub 106 is connected to. The participant registry 211 could then replicate, distribute, or synchronize the RTP registration data 217 with other participant registries 211 of other supernetwork instances 203.

Subsequently, the network hub 106 could provide a list of all participants in the RTP network 100 of the network hub 106 to the global transaction router 206 of the supernetwork instance 203. This could include the network identifier 109 of the RTP network 100 of the network hub 106, as well as the participant identifiers 116 of the participant systems 103 of the RTP network 100 of the network hub 106. In response, the global transaction router 206 could create and save a participant record 216 for each of the participants of the RTP network 100 of the network hub 106 to the participant status cache 209. The participant status cache 209 could then replicate, distribute, or synchronize the newly created participant records 216 to other participant status caches 209 of other supernetwork instances 203.

Later, a network hub 106 of a first RTP network 100 (e.g., network hub 106a) could receive a payment request from a participant system 103 to send a payment to a second participant system 103 that is part of a second RTP network 100 that uses a second network hub 106 (e.g., network hub 106h). The first network hub 106a could determine that the recipient of the transaction is not a member of the first RTP network 100. In response, the first network hub 106a could create and send a payment request to the global transaction router 206a executed by the supernetwork instance 203a that the network hub 106a is connected to.

The global transaction router 206a could evaluate the payment request to determine where to route the payment request. For example, the global transaction router 206a could query the participant status cache 209a to determine whether there is a participant record 216 matching a participant identifier 116 for the recipient. If a participant record 216 exists, the global transaction router 206a could retrieve the network identifier 109 to determine which network hub 106 to route the payment request to. If the network identifier 109 fails to match the network identifier 109 of a network hub 106 connected to the supernetwork instance 203a, then the global transaction router 206a could query the RTP registration data 217 in the participant registry 211a to determine which supernetwork instance 203 (e.g., supernetwork instance 203b) the payment request should be routed to. The global transaction router 206a could then send the payment request to the appropriate global transaction router 206b.

The global transaction router 206b can receive the payment request and evaluate it to determine which network hub 106 to route the payment request to. For example, the global transaction router 206b could compare the network identifier 109 specified in the payment request to the network identifiers 109 of the network hubs 106 connected to the supernetwork instance 203b. If the network identifier 109 in the payment request matches the network identifier 109 of a connected network hub 106, such as network hub 106h, then the global transaction router 206b could forward the payment request to the recipient network hub 106h.

The recipient network hub 106h could return a response message, which either accepts or rejects the payment request, to the global transaction router 206b. The global transaction router 206b could then relay the response message to the global transaction router 206a, and the global transaction router 206a could relay the response message to the source network hub 106a.

Referring next to FIG. 3, shown is a flowchart that provides one example of the operation of a portion of a network hub 106. The flowchart of FIG. 3 provides merely an example of the many different types of functional arrangements that can be employed to implement the operation of the depicted portion of the network hub 106. As an alternative, the flowchart of FIG. 3 can be viewed as depicting an example of elements of a method implemented within the RTP network 100 or the supernetwork 200.

Beginning with block 303, the network hub 106 can receive a payment request from a participant system 103. The payment request can include information such as the participant identifier 116 of the recipient, the participant identifier 116 of the payee, the amount of the payment, and potentially other information.

Then, at block 306, the network hub 106 can determine whether the balance 119 of the participant account 113 associated with the participant identifier 116 of the payee that submitted the payment request at block 303 has sufficient funds to settle the payment. If the balance 119 of the participant account 113 has insufficient funds to settle the payment, then the process can end. Optionally, the network hub 106 could send a rejection or error message to the participant system that submitted the payment request. However, if the balance 119 of the participant account 113 has sufficient funds, then the process can proceed to block 309.

Moving on to block 309, the network hub 106 can determine if the recipient identified in the payment request is a participant in the RTP network 100. For example, the network hub 106 could search for a participant account 113 with a participant identifier 116 matching the participant identifier 116 specified in the payment request. If the matching participant account 113 is found, then the network hub 106 can determine that the recipient is a member of the RTP network 100 and the process can proceed to block 313. However, if a matching participant account 113 is not found, then this would indicate that the recipient is not a member of the RTP network 100. In this situation, the process could proceed to block 319.

If the process proceeds to block 313, the network hub 106 can adjust the account balance 119 of the participant account 113 of the payer. For example, the network hub 106 could deduct an amount of funds from the account balance 119 equal to the amount of funds specified in the payment request.

Next, at block 316, the network hub 106, can similarly adjust the account balance 119 of the participant account 113 of the recipient. For example, the network hub 106 could add an amount of funds to the account balance 119 of the recipient equal to the amount of funds specified in the payment request.

However, if the process instead proceeds to block 319, the network hub 106 can place a hold on the account balance 119 of the participant account 113 of the payer that submitted the payment request at block 303. This hold can be done to prevent double-spending of funds held in the participant account 113 of the payer while the network hub 106 forwards the payment request to a global transaction router 206 of a supernetwork instance 203.

Then, at block 323, the network hub 106 can forward the payment request to the global transaction router 206 of the supernetwork instance 203 that the network hub 106 is connect to. In some implementations, the network hub 106 could create a new payment message or payment request that satisfies any protocol requirements of the supernetwork 200. Generally, such a new payment message or payment request would include at least the same information that is included in the original payment, but be formatted in a standardized way that could be processed by the global transaction router 206.

Moving on to block 326, the network hub 106 can wait until it receives a payment response message from the global transaction router 206 of the supernetwork instance 203 that the network hub 106 is connected to. Once the payment response message is received, the network hub 106 can analyze the payment response message to determine if the payment request was accepted by the recipient network hub 106 or if the payment request was rejected. If the payment response message indicates that the payment request was accepted, then the process can proceed to block 329. However, if the payment response message indicates that the payment request was rejected, then the process can skip to block 336.

If the process proceeds to block 329, the network hub 106 can adjust the payer account balance 119. For example, the network hub 106 could deduct an amount of funds from the account balance 119 equal to the amount specified in the payment request. In some instances, the payment response message could include additional transaction fees (e.g., transaction fees required by the supernetwork 200 or the recipient network hub 106 to process the payment). In these instances, the additional transaction fees could also be deducted from the account balance 119 of the participant account 113 of the payer.

Next, at block 333, the network hub 106 can adjust the account balance 119 of a participant account 113 associated with the operator of the supernetwork 200. For example, the network hub 106 could add an amount of funds equal to the amount specified in the payment request and any additional transaction fees to the account balance 119 of the participant account 113 of the supernetwork 200.

Once the process proceeds to block 336, the network hub 106 can release the hold on the account balance 119 of the participant account 113 of the payer. Then, the process could end.

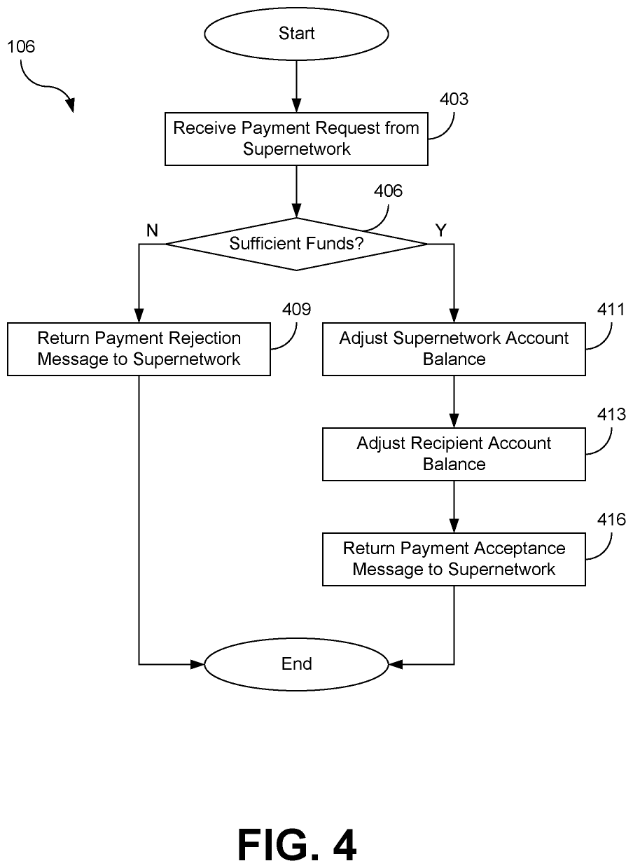

Referring next to FIG. 4, shown is a flowchart that provides one example of the operation of a portion of a network hub 106. The flowchart of FIG. 4 provides merely an example of the many different types of functional arrangements that can be employed to implement the operation of the depicted portion of the network hub 106. As an alternative, the flowchart of FIG. 4 can be viewed as depicting an example of elements of a method implemented within the RTP network 100 or the supernetwork 200.

Beginning with block 403, a network hub 106 can receive a payment request from a global transaction router 206 of a supernetwork instance 203 connected to the network hub 106. For example, if a first network hub 106a forwarded a payment request to the global transaction router 206a using the process described in FIG. 3, then a recipient network hub 106 (e.g., network hub 106h) could receive a corresponding payment request from the global transaction router 206b of the supernetwork instance 203b.

Then, at block 406, the network hub 106 can determine whether the account balance 119 of the participant account 113 associated with the operator of the supernetwork 200 has sufficient funds to complete the transaction. If there are insufficient funds (e.g., because the payment request is larger than the current account balance 119 of the supernetwork 200 within the RTP network 100), then the process can proceed to block 409. However, if there are sufficient funds to complete the payment request, then the process can proceed to block 411.

If the process proceeds to block 409, then the network hub 106 can generate a payment rejection message and return the payment rejection message to the global transaction router 206 of the supernetwork instance 203 that the network hub 106 is connected to. The payment rejection message can include the participant identifier 116 of the source of the payment and, potentially, the network identifier 109 of the source of the payment. In some instances, the payment rejection message could include a reason why the payment was rejected, while in other instances the reason for the rejection of the payment request could be omitted.

However, if the process proceeds to block 411, then the network hub 106 can adjust the account balance 119 of a participant account 113 associated with the operator of the supernetwork 200. For example, the network hub 106 could deduct an amount of funds equal to the amount specified in the payment request. The network hub 106 could also deduct any additional transaction fees from the account balance 119 of the participant account 113 of the operator of the supernetwork 200 to compensate the RTP network 100 operator for the costs of processing the transaction.

Next, at block 413, the network hub 106 can adjust the account balance 119 of the participant account 113 of the recipient. Accordingly, the network hub 106 could search for the participant account 113 matching the participant identifier 116 specified in the payment request. The network hub 106 could then add an amount of funds to the account balance 119 of the matching participant account 113 equal to the amount specified in the payment request.

Subsequently, at block 416, the network hub 106 could generate and return a payment acceptance message to the global transaction router 206 of the supernetwork instance 203 that the network hub 106 is connected to. The payment acceptance message could include information such as a confirmation code or number, a confirmation of the amount deposited to the account balance 119 of the recipient, a timestamp indicating the time at which the recipient received the funds, the participant identifier 116 of the source of the payment and, potentially, the network identifier 109 of the source of the payment, as well as other information. The process can then subsequently end.

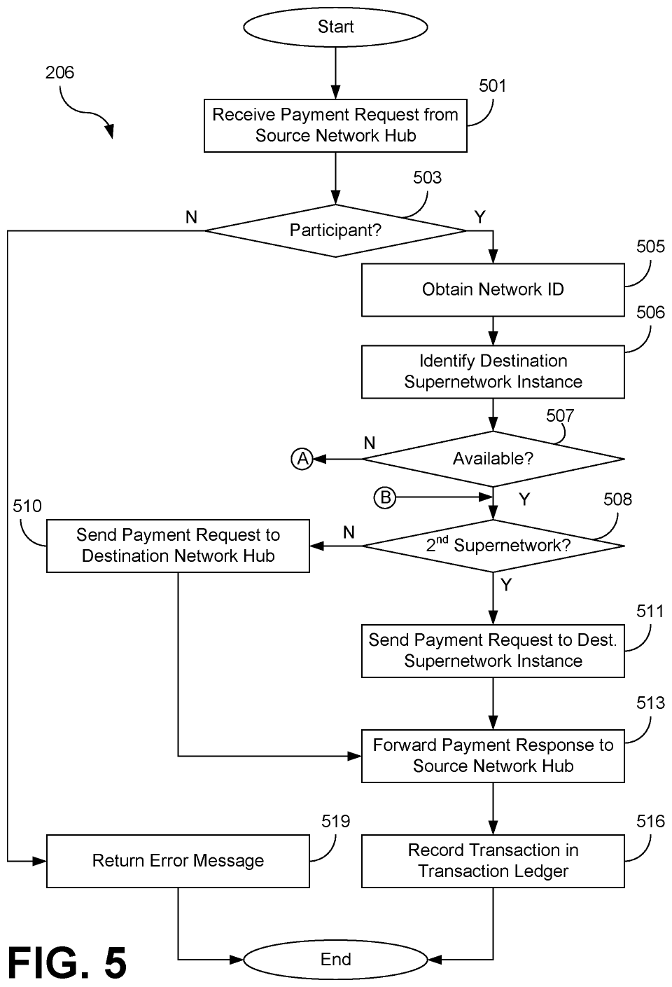

Referring next to FIG. 5, shown is a flowchart that provides one example of the operation of a portion of the global transaction router 206. The flowchart of FIG. 5 provides merely an example of the many different types of functional arrangements that can be employed to implement the operation of the depicted portion of the global transaction router 206. As an alternative, the flowchart of FIG. 5 can be viewed as depicting an example of elements of a method implemented within the supernetwork 200.

Beginning with block 501, the global transaction router 206 can receive a payment request from a source network hub 106. For example, the payment request could have been received as part of the process performed by the source network hub 106 at block 323. The payment request can include information such as the network identifier 109 and participant identifier 116 of the participant making the payment, the participant identifier 116 of the recipient, the network identifier 109 of the participant (if known), the amount of the payment, and potentially other information depending on the particular implementation of the present disclosure.

Moving on to block 503, the global transaction router 206 can determine whether the recipient of the payment request is a participant of an RTP network 100 with a network hub 106 connected to a supernetwork instance 203 of the supernetwork 200. This network hub 106 would be the destination network hub 106 for the payment request. For example, the global transaction router 206 could search the participant status cache 209 to identify a participant record 216 with a matching participant identifier 116. If a participant record 216 exists, then the process can proceed to block 505. If no participant record 216 exists, then the process can instead skip to block 519.

Then, at block 505, the global transaction router 206 can obtain the network identifier 109 for the destination network hub 106 from the participant record 216 identified at block 503.

Next, at block 506, the global transaction router 206 can identify the supernetwork instance 203 which the destination network hub 106 associated with the destination network identifier 109 obtained at block 506 is connected to. For example, the global transaction router 206 could search the RTP registration data 217 in the participant registry 211 to identify the supernetwork instance 203 that is associated with the network identifier 109. However, in some implementations, the global transaction router 206 could cache a list of network hubs 106 that it is connected to, in which case the global transaction router 206 could query its cache instead of the participant cache registry 211.

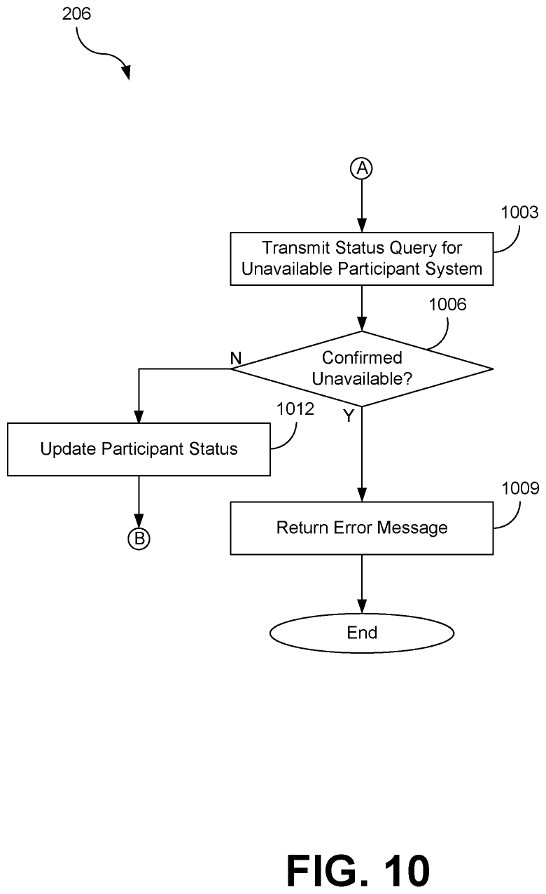

At block 507, the global transaction router 206 can determine whether the recipient has an available participant system 103 for receiving the payment request. The participant ID 116 can be used to query for a participant record 216 with a matching participant ID 116 for a given network identifier (ID) 109. The participant record 216 can have the participant status 120 for the participant system 103. The participant status 120 for the recipient can indicate whether the recipient has a participant system 103 that is available for the payment request. Additionally, the participant status 120 can indicate one or more payment features 719 that are available for processing the payment request. If a participant system 103 is available for the recipient, then the global transaction router 206 can proceed to block 508. If a participant system 103 is not available for the recipient, then the global transaction router 206 can proceed to circle A (see FIG. 10) to initiate a query to confirm that a participant system 103 is not available. If a query response from a network hub 106 or a supernetwork instance 203 indicates that the participant system 103 is available, then the global transaction router 206 returns from circle B (see FIG. 10) and proceeds to block 508. If the participant system 103 is not available, FIG. 10 describes a process for returning an error message. In some embodiments, the functionality for block 507 can be omitted.

Proceeding to block 508, the global transaction router 206 can determine whether the destination network hub 106 for the payment request is connected to the supernetwork instance 203 (e.g., supernetwork instance 203a) hosting the global transaction router 206, or is connected to a second supernetwork instance 203 (e.g., supernetwork instance 203b). This can be done by determining whether the supernetwork instance 203 identified at block 507 is the same supernetwork instance 203 hosting the global transaction router 206. If the destination network hub 106 is connected to the same supernetwork instance 203 that is hosting the global transaction router 206, then the process can proceed to block 510. However, if the destination network hub 106 is connected to a second supernetwork instance 203, then the process can proceed to block 511.

If the process proceeds to block 510, the global transaction router 206 can send the payment request to the destination network hub 106 that is connected to the supernetwork instance 203 hosting the global transaction router 206. The global transaction router 206 can then wait to receive a response from the destination network hub 106 regarding the payment status.

However, if the process proceeds to block 511, the global transaction router 206 can send the payment request to the global transaction router 206 hosted by the supernetwork instance 203 identified at block 506. The global transaction router 206 can then wait to receive a response from the second global transaction router 206 regarding the payment status.

Later, at block 513, the global transaction router 206 can receive a payment response indicating the status of the payment request and return or forward it to the source network hub 106. For example, the global transaction router 206 could search the participant status cache 209 to identify a participant record 216 with a matching participant identifier 116. The global transaction router 206 could then determine the network identifier 109 for the destination of the message and determine that the network identifier 109 is for a network hub 106 (e.g., the source network hub 106) connected to the supernetwork instance 203 hosting the global transaction router 206. For example, the global transaction router 206 could query the RTP registration data 217 in participant cache registry 211 to determine that the destination network hub 106 is connected to the global transaction router 206. However, in some implementations, the global transaction router 206 could cache a list of network hubs 106 that it is connected to, in which case the global transaction router 206 could query its cache instead of the participant cache registry 211.

The global transaction router 206 can also cache or temporarily store the payment response for use at block 516.

Then, at block 516, the global transaction router 206 can store or record the transaction in the transaction ledger 213. For example, if the payment response received at block 513 were a payment acceptance message, then the global transaction router 206 could record a transaction record 219 in the transaction ledger 213 containing information such as a confirmation code or number, a confirmation of the amount deposited to the account balance 119 of the recipient, a timestamp indicating the time at which the recipient received the funds, the participant identifier 116 of the source of the payment, and potentially, the network identifier 109 of the source of the payment, as well as other information. Likewise, if the payment response were a payment rejection message, then the global transaction router 206 could record a transaction record 219 in the transaction ledger 213 containing the participant identifier 116 of the source of the payment, and potentially, the network identifier 109 of the source of the payment. In some instances, the payment rejection message could include a reason why the payment was rejected, in which case the reason for the rejection could also be included in the transaction record 219. The process could then end.

If the process proceeds to block 519, the global transaction router 206 can generate and return an error message to the source network hub 106 indicating that the payment request could not be completed. In some implementations, the error message could include an indication of the problem (e.g., destination is not a member of a supported RTP network 100, the supernetwork has insufficient funds at the destination, etc.). Once the error message is sent, the process can end.

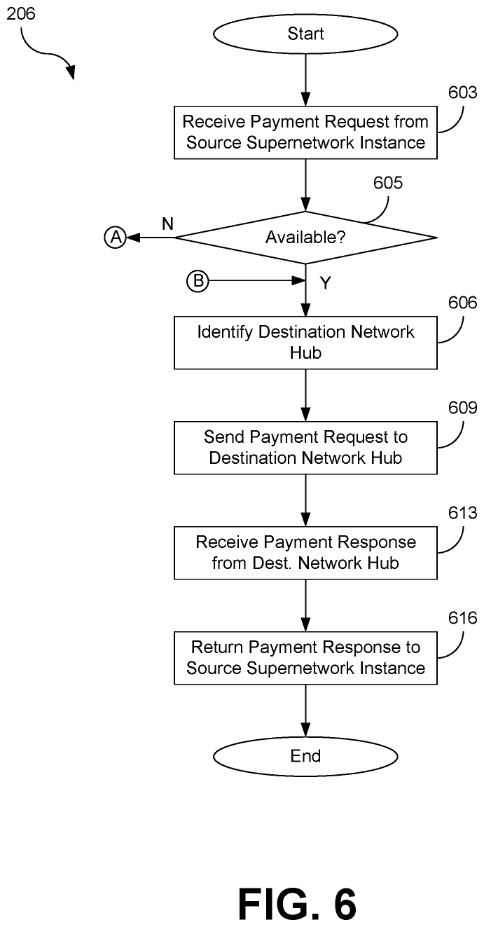

Referring next to FIG. 6, shown is a flowchart that provides one example of the operation of a portion of the global transaction router 206. The flowchart of FIG. 6 provides merely an example of the many different types of functional arrangements that can be employed to implement the operation of the depicted portion of the global transaction router 206. As an alternative, the flowchart of FIG. 6 can be viewed as depicting an example of elements of a method implemented within the supernetwork 200.

Beginning with block 603, the global transaction router 206 (e.g., global transaction router 206b) of a second supernetwork instance (e.g., supernetwork instance 203b) can receive a payment request from a first global transaction router 206 (e.g., global transaction router 206a) hosted or executed by a first supernetwork instance (e.g., supernetwork instance 203a). The payment request could be received as a result of the first global transaction router 206 determining that the second global transaction router 206 has a connection to the network hub 106 of the recipient of the payment. An example of this process has been previously discussed and illustrated by FIG. 5.

At block 605, the global transaction router 206 can determine whether the recipient has an available participant system 103 for receiving the payment request. The participant ID 116 can be used to query the participant status 120 in the participant records 216. The participant status 120 for the recipient can indicate whether the recipient has a participant system 103 that is available for the payment request. Additionally, the participant status 120 can indicate one or more payment features 719 that are available for processing the payment request. If a participant system 103 is available for the recipient, then the global transaction router 206 can proceed to block 606. If a participant system 103 is not available for the recipient, then the global transaction router 206 can proceed to circle A (see FIG. 10) to initiate a query to confirm that a participant system 103 is not available. If a query response from a network hub 106 or a supernetwork instance 203 indicates that the participant system 103 is available, then the global transaction router 206 returns from circle B (see FIG. 10) and proceeds to block 606. If the participant system 103 is not available, FIG. 10 describes a process for returning an error message.

In some embodiments, the functionality for block 605 can be omitted. For example, the source supernetwork instance 203 that sent the payment request may have checked the participant status 120 of the destination participant system 103 before transmitting the payment request to the destination supernetwork instance 203. However, it may be desirable to confirm the participant status 120 of the destination participant system 103 again, because there is a possibility that the participant status 120 can change during the routing between the source supernetwork instance 203 and the destination supernetwork instance 203.

Then, at block 606, the global transaction router 206 can identify the destination network hub 106. For example, the global transaction router 206 could analyze the payment request to determine the participant identifier 116 of the recipient. The global transaction router 206 could then query the participant status cache 209 to search for a participant record 216 with a matching participant identifier 116. The global transaction router 206 could then retrieve the network identifier 109 from the participant record 216. The global transaction router 206 could then query the RTP registration data 217 in the participant cache registry 211 to determine that the destination network hub 106 is connected to the global transaction router 206. However, in some instances, the global transaction router 206 could cache a list of network hubs 106 that it is connected to, in which case the global transaction router 206 could query its cache instead of the participant cache registry 211.

Next, at block 609, the global transaction router 206 could then forward or otherwise send the payment request received at block 603 to the network hub 106 identified at block 606.

Moving on to block 613, the global transaction router 206 can receive a payment response from the destination network hub 106 that the payment request was forwarded to at block 609. The payment response, as previously discussed, could be a payment acceptance, a payment rejection, or another payment status message.

Subsequently, at block 616, the global transaction router 206 can return the payment response received at block 613 to the source supernetwork instance 203 from which the payment request was received at block 603. For example, the global transaction router 206 could search the participant status cache 209 to identify a participant record 216 with a matching participant identifier 116 specifying the source of the payment and, therefore, the destination for the payment response. The global transaction router 206 could obtain the network identifier 109 from the identified participant record 216. This could be skipped, however, in those instances where the payment response included the network identifier 109 identifying the destination of the payment response. The global transaction router 206 could then search the RTP registration data 217 in the participant registry 211 to identify the supernetwork instance 203 that is associated with the network identifier 109, and forward the payment response to the identified supernetwork instance 203. The process can subsequently end.

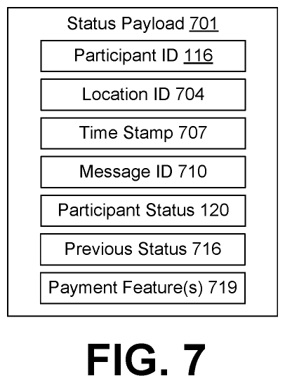

Moving on to FIG. 7, shown is block diagram depicting an example of a status payload 701 for a participant system 103. The status payload 701 can represent a data object that is used to describe a current participant status 120 of the participant system 103 and other related data elements associated with the participant status 120. As such, the status payload 701 is one non-limiting example of a data object that is communicated among the participant system 103, the network hub 106, the supernetwork instance 203, and other computing entities. Various entities in the RTP network 100 and/or the supernetwork 200 can determine the current participant status 120 of the participant system 103 before a payment is initiated or completed. The status payload 701 can include the participant ID 116 for the participant system 103, a location identifier (ID) 704, a time stamp 707, a message identifier (ID) 710, a participant status 120, a previous status 716, a payment feature 719, and other suitable data elements.

The participant ID 116 can be any identifier that uniquely identifies a participant system 103, and therefore a participant, with respect to another participant system 103, and therefore another participant. In some instances, the participant ID 116 can be a unique identifier that identifies the participant system 103 among other participant systems 103 on other RTP networks 100 and supernetwork instances 203. For example, the participant ID 116 can incorporate a network identifier 109. In other instances, the participant ID 116 and the network identifier 109 can be separate. Thus, in some examples, the participant ID 116 can be used by the network hub 106 and the supernetwork instance 203 for routing payments.

The location ID 704 can represent an identifier for a physical location of a data center for the participant system 103. The data center location can be used for routing payments and status queries. In some instances, the location ID 704 can be used to identify a data center status. For example, in some instances, the participant system 103 can be associated with a first data center at a first geographical location and a second data center at a second geographical location. In this example, the location ID 704 can be used to identify a status at each data center.

The time stamp 707 can represent a point in time at which the participant status 120 was determined. In some examples, the time stamp 707 can be generated by the entity that determined the participant status 120. In other instances, the time stamp 707 can represent a point in time at which the participant status 120 was verified. The message ID 710 can represent an identifier for uniquely identifying a message that includes the status payload 701.

The participant status 120 can be one or more statuses of a participant system 103 at a particular time. The participant status 120 can represent an availability and/or a capability to send or receive payments on the RTP network 100 and/or the supernetwork 200. Some non-limiting examples of the participant status 120 can include physically connected (e.g., but not ready for a payment request) to the RTP network 100, signed on to the RTP network 100 and ready to process a payment request, signed off of the RTP network 100, and disconnected from the RTP network 100 or the supernetwork 200.

The previous status 716 can represent a previous instance of the participant status 120 after the participant status 120 has been changed. The previous status 760 can be used for diagnosing an error with a participant system 103.

The payment feature 719 can represent one or more payment capabilities of the participant system 103. The source participant system 103 can determine whether to initiate a payment request and the type of payment request based at least in part on one or more payment features 719. Some non-limiting payment features 719 can include a network speed metric, a monetary cost for a payment request, supported payment types (e.g., ACH, FTP, Book Transfers), and other suitable payment capabilities.

In one example, the network hub 106 can receive data from a participant system 103 regarding an update to its participant status 120. The network hub 106 can identify one or more data elements for generating the status payload 701. After the status payload 701 has been generated, the network hub 106 can transmit the status payload 701 to a connected supernetwork instance 203.

The supernetwork instance 203 can store the data elements of the status payload 701 in a participant record 216 associated with the participant ID 116. The global transaction router 206 can propagate the status payload 701 to other connected network hubs 106 and other connected supernetwork instances 203.

In another example, the global transaction router 206 can query the participant status 120 of the participant system 103 on a periodic timing interval from the network hubs 106. As such, the global transaction router 206 can submit a query on a periodic timing interval or upon demand to the network hubs 106 for an update on the participant systems 103. The network hubs 106 can transmit a status payload 701 in response to the query.

In another example, a first supernetwork instance 203a can receive a payment request from a second supernetwork instance 203b. In this example, the payment request has a destination participant system 103 connected to the first supernetwork instance 203a. The first supernetwork instance 203a can query the participant status cache 209a in the participant status cache 209b. If the stored participant status 120 indicates that the destination participant system 103 is unavailable, then the global transaction router 206a can submit a query to the network hub 106 associated with the destination participant system 103 to verify that the destination participant system 103 is unavailable. The network hub 106 can respond to the query with a status payload 701 for the destination participant system 103.

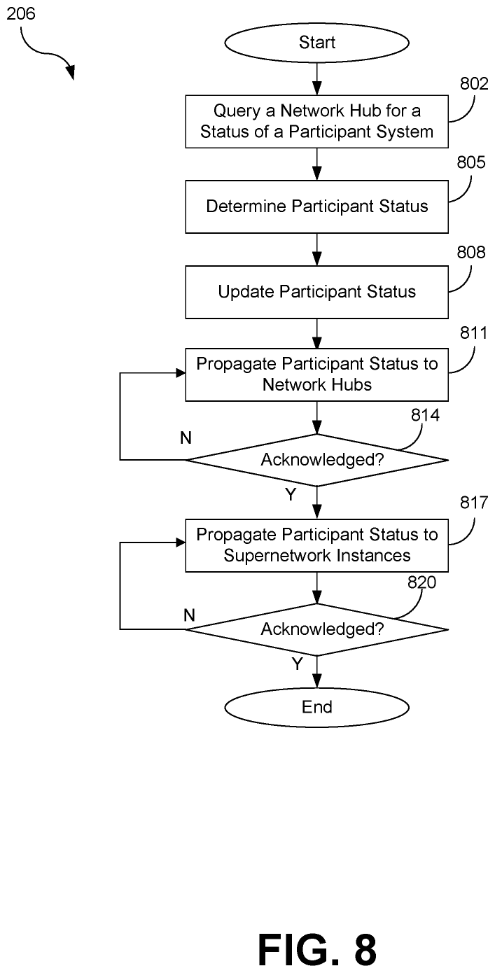

Referring next to FIG. 8, shown is a flowchart that provides one example of the operation of a portion of a first supernetwork instance 203 (e.g., supernetwork instance 203a). The flowchart of FIG. 8 provides merely an example of the many different types of functional arrangements that can be employed to implement the operation of the depicted portion of the first supernetwork instance 203 (e.g., supernetwork instance 203a). As an alternative, the flowchart of FIG. 8 can be viewed as depicting an example of elements of a method implemented within the RTP network 100 or the supernetwork 200.

In block 802, the global transaction router 206 can transmit to a first network hub 106 a query for a participant status 120 of a participant system 103. In some instances, the global transaction router 206 can transmit the query on a periodic time interval or upon demand in response to an event, such as receiving a payment request or other suitable events.

In block 805, the global transaction router 206 can determine the participant status 120 based at least in part on a query response or a failure to receive a query response from the first network hub 106. For example, the first network hub 106 can transmit a query response as a reply to a query transmitted by the global transaction router 206. In some examples, the query response can include the status payload 701. In some instances, the query response can indicate a change in participant status 120, such as a change from disconnected to signed on. Additionally, the first network hub 106 can communicate data related to a change in payment features 719 for a particular participant system 103. For example, the network speed for the participant system 103 may have been decreased or the participant system 103 may support a different set of RTP networks 100 from a previous instance.

In some examples, the network hub 106 can transmit an update to the participant status 120 for a participant system 103 without a query being sent from the first supernetwork instance 203 (e.g., supernetwork instance 203a). For instance, the participant system 103 may have a scheduled maintenance operation to perform that requires the participant system 103 to be disconnected for a day. Before the participant system 103 is disconnected, the participant system 103 can inform the network hub 106 that it's participant status 120 is going to be disconnected for a period of time (e.g., for twelve hours). The network hub 106 can receive the updated participant status 120 and relay the participant status 120 to the supernetwork instance 203. In some embodiments, the network hub 106 and the participant system 103 can communicate the participant status 120 in a status payload 701.

In other instances, the global transaction router 206 may not receive a query response from the first network hub 106 after an expiration of a time period for receiving the query response. As such, the global transaction router 206 can determine the participant status 120 based at least in part on the failure to receive a query response from one or more query attempts.

In block 808, the global transaction router 206 can update the participant status 120 for the participant system 103 at the participant status cache 209 based at least in part on determining a new participant status 120. In some examples, the global transaction router 206 can transmit an acknowledgement of the updated participant status 120 to the network hub 106.

In block 811, the global transaction router 206 can propagate the participant status 120 to other network hubs 106 connected to the first supernetwork instance 203 (e.g., supernetwork instance 203a). In some examples the global transaction router 206 can identify the other network hubs 106 connected to the supernetwork instance 203 by querying the participant records 216. The propagation of the participant status 120 can include transmitting data for the status payload 701 to each connected network hub 106 for the supernetwork instance 203.

In block 814, the global transaction router 206 can determine whether an acknowledgement has been received from one or more network hubs 106. If an acknowledgement is received, then the global transaction router 206 can proceed to block 817. If an acknowledgment is not received, then the global transaction router 206 can proceed to block 811 for retransmitting the status payload 701 to one or more network hubs that have failed to provide an acknowledgement.

In some examples, the global transaction router 206 can maintain a count of a number of propagations of the participant status 120 that have been made for a participant status 120. If a threshold number of propagations have failed to receive an acknowledgement, then the global transaction router 206 can indicate an error.

In block 817, the global transaction router 206 can propagate the participant status 120 to other connected supernetwork instances 203 (e.g., supernetwork instance 203b). In some examples, the global transaction router 206 can query the participant registry 211 to identify other connected supernetwork instances 203 (e.g., supernetwork instance 203b).

In block 820, the global transaction router 206 can determine whether an acknowledgement has been received from one or more supernetwork instances 203. If an acknowledgement is received, then the global transaction router 206 can proceed to the end. If an acknowledgment is not received, then the global transaction router 206 can proceed to block 817 for retransmitting the status payload 701 to one or more supernetwork instances 203 that have failed to provide an acknowledgement.

In some examples, the global transaction router 206 can maintain a count of a number of propagations of the participant status 120 have been made for a participant status 120. If a threshold number of propagations have failed to receive an acknowledgement, then the global transaction router 206 can indicate an error.

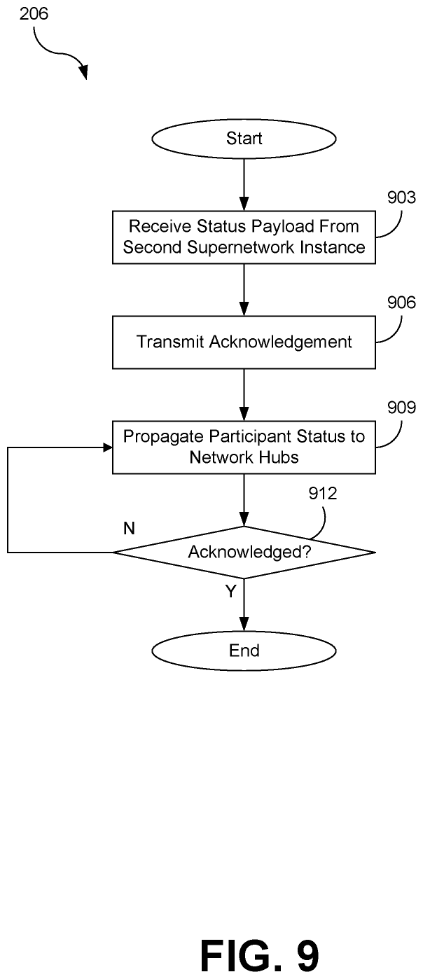

Referring next to FIG. 9, shown is a flowchart that provides one example of the operation of a portion of a first supernetwork instance 203 (e.g., supernetwork instance 203a). The flowchart of FIG. 9 provides merely an example of the many different types of functional arrangements that can be employed to implement the operation of the depicted portion of the first supernetwork instance 203 (e.g., supernetwork instance 203a). As an alternative, the flowchart of FIG. 9 can be viewed as depicting an example of elements of a method implemented within the RTP network 100 or the supernetwork 200.

In block 903, the global transaction router 206 can receive a status payload 701 from a second supernetwork instance 203 (e.g., supernetwork instance 203b). The status payload 701 can include one or more data elements, such as the participant ID 116, the location ID 704, the time stamp 707, the message ID 710, the participant status 120, the previous status 716, the payment feature 719, and other suitable data elements.

In block 906, the global transaction router 206 can transmit an acknowledgement to the second supernetwork instance 203 (e.g., supernetwork instance 203b). In some examples, the global transaction router 206 can determine that an acknowledgement should be transmitted based at least in part on identifying the status payload 701.

In block 909, the global transaction router 206 can propagate participant status 120 to the network hubs 106. In some examples, the global transaction router 206 can query the participant records 216 to identify other network hubs 106 connected to the first supernetwork instance 203 (e.g., supernetwork instance 203a).

In block 912, the global transaction router 206 can determine whether one or more network hubs 106 have received an acknowledgement. If an acknowledgement has been received, the global transaction router 206 can proceed to the end. If an acknowledgement has not been received, the global transaction router 206 can proceed to block 909.

Referring next to FIG. 10, shown is a flowchart that provides one example of the operation of a portion of a first supernetwork instance 203 (e.g., supernetwork instance 203a). The flowchart of FIG. 10 provides merely an example of the many different types of functional arrangements that can be employed to implement the operation of the depicted portion of the first supernetwork instance 203 (e.g., supernetwork instance 203a). As an alternative, the flowchart of FIG. 10 can be viewed as depicting an example of elements of a method implemented within the RTP network 100 or the supernetwork 200.

In block 1003, the global transaction router 206 can transmit a status query for an unavailable participant system 103. The status query can be transmitted in order to confirm that the unavailable participant system 103 is indeed unavailable. As such, the global transaction router 206 can transmit the status query to the network hub 106 connected to the participant system 103. The network hub 106 can relay the status query to the network hub 106, which will in turn transmit the status query to the participant system 103.

In block 1006, the global transaction router 206 can determine whether to confirm the unavailability of the participant system 103 based at least in part on a query response or a failure to receive a query response. If the unavailability of the participant system 103 is confirmed, then the global transaction router 206 can proceed to block 1009. If the unavailability of the participant system 103 is not confirmed, then the global transaction router 206 can proceed block 1012. For example, the global transaction router 206 can determine that the participant system 103 is actually available and a current participant status 120 is determined for the participant system 103.

In block 1009, the global transaction router 206 can return an error message to the second supernetwork instance 203 (e.g., supernetwork instance 203b). The error message can indicate that a particular participant system 103 is unavailable. Then, the global transaction router 206 can proceed to the end. In block 1012, the global transaction router 206 can update the participant status 120 for the participant system 103 in the participant status cache 209.

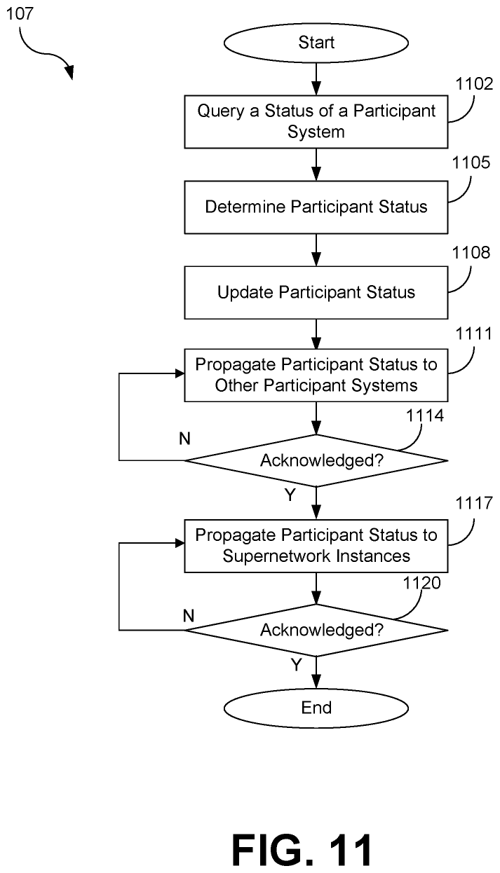

Referring next to FIG. 11, shown is a flowchart that provides one example of the operation of a portion of a network hub 106. The flowchart of FIG. 11 provides merely an example of the many different types of functional arrangements that can be employed to implement the operation of the depicted portion of the network hub 106. As an alternative, the flowchart of FIG. 11 can be viewed as depicting an example of elements of a method implemented within the RTP network 100 or the supernetwork 200.

In block 1102, the transaction router 107 can transmit a query for a participant status 120 to a participant system 103. In some instances, the transaction router 107 can transmit the query on a periodic time interval or upon demand in response to an event, such as receiving a payment request, failure to receive communication from the participant system 103 after a threshold time period, or other suitable events. In some instances, the participant system 103 can provide data related to a participant status 120 that is unsolicited from the network hub 106. For example, a participant system 103 may have a scheduled maintenance operation to perform that requires the participant system 103 to be disconnected for a day. Before the participant system 103 is disconnected, the participant system 103 can inform the network hub 106 that it's participant status 120 is going to be disconnected for a period of time (e.g., for twelve hours). The network hub 106 can receive the updated participant status 120 and relay the participant status 120 to the supernetwork instance 203. In some embodiments, the network hub 106 and the participant system 103 can communicate the participant status 120 in a status payload 701.

In block 1105, the transaction router 107 can determine the participant status 120 based at least in part on a query response or a failure to receive a query response from the participant system 103. For example, the participant system 103 can transmit a query response as a reply to a query transmitted by the transaction router 107. In some examples, the query response can include the status payload 701. In some instances, the query response can indicate a change in the participant status 120, such as a change from disconnected to signed on. Additionally, the participant system 103 can communicate data related to a change in payment features 719 for the participant system 103. For example, the network speed for the participant system 103 may have been decreased or the participant system 103 may support a different set of RTP networks 100 from a previous instance.

In some examples, the participant system 103 can transmit to the network hub 106 an update for the participant status 120 for a participant system 103 without a query being sent from the network hub 106. For instance, the participant system 103 may have a scheduled maintenance operation to perform that requires the participant system 103 to be disconnected for a day. Before the participant system 103 is disconnected, the participant system 103 can inform the network hub 106 that it's participant status 120 is scheduled to be disconnected for a period of time (e.g., for twelve hours) starting on a particular day and time. The network hub 106 can use the data regarding the scheduled maintenance to determine the participant status 120 at the time of the scheduled maintenance. In some embodiments, the network hub 106 and the participant system 103 can communicate the participant status 120 in a status payload 701.

In other instances, the transaction router 107 may not receive a query response from the participant system 103 after an expiration of a time period for receiving the query response. As such, the transaction router 107 can determine the participant status 120 based at least in part on the failure to receive a query response from one or more query attempts meeting a threshold.

In block 1108, the transaction router 107 can update the participant status 120 for the participant system 103 at the participant account 113 based at least in part on determining the participant status 120. In some examples, the transaction router 107 can transmit an acknowledgement of the updated participant status 120 to the participant system 103.

In block 1111, the transaction router 107 can propagate the participant status 120 to other participant systems 103 connected to the network hub 106. In some examples the transaction router 107 can identify the other participant systems 103 connected to the network hubs 106 by querying the participant accounts 113. The propagation of the participant status 120 can include transmitting data for the status payload 701 to each connected participant system 103 for the network hub 106.

In block 1114, the transaction router 107 can determine whether an acknowledgement has been received from one or more participant systems 103 with a threshold time period. If an acknowledgement is received, then the transaction router 107 can proceed to block 1117. If an acknowledgment is not received, then the global transaction router 206 can proceed to block 1111 for retransmitting the status payload 701 or the participant status 120 to one or more participant systems 103 that have failed to provide an acknowledgement.

In some examples, the transaction router 107 can maintain a count of a number of propagations of the participant status 120 have been made for a participant status 120. If a threshold number of propagations have failed to receive an acknowledgement, then the transaction router 107 can indicate an error.

In block 1117, the transaction router 107 can propagate the participant status 120 to the supernetwork instances 203. In some examples, the transaction router 107 can identify a predetermined supernetwork instance 203 connected to the network hub 106. In other examples, the transaction router 107 can query the participant account 113 or other stored records in the network hub 106.

In block 1120, the transaction router 107 can determine whether an acknowledgement has been received from the supernetwork instances 203. If an acknowledgement is received, then the transaction router 107 can proceed to the end. If an acknowledgment is not received, then the transaction router 107 can proceed to block 1117 for retransmitting the status payload 701 to the supernetwork instances 203 that have failed to provide an acknowledgement.

In some examples, the transaction router 107 can maintain a count of a number of propagations of the participant status 120 or the status payloads 701 that have been made to the supernetwork instance 203. If a threshold number of propagations have failed to receive an acknowledgement, then the transaction router 107 can indicate an error.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
a first global transaction router hosted by a first supernetwork instance, the first global transaction router comprising machine-readable instructions stored in the memory that, when executed by the processor, cause the computing device to at least:
transmit a query to a first network hub for a status of a participant system, the participant system being connected to the first network hub;
determine a participant status for the participant system based at least in part on a query response from the first network hub;
update a participant status cache based at least in part on the participant status;
propagate the participant status to a second network hub connected to the first supernetwork instance; and
propagate the participant status to a second supernetwork instance connected to the first supernetwork instance.

2. The system of claim 1, wherein the participant status comprises a participant identifier for the participant system and a payment network status for the participant system.

3. The system of claim 2, wherein the participant identifier identifies the first supernetwork instance and the first network hub for routing a payment request to the participant system.

4. The system of claim 1, wherein the participant status for the participant system is further determined based at least in part on a status threshold and a plurality of query responses from the first network hub, the plurality of query responses comprising the query response.

5. The system of claim 1, wherein the query for the first network hub is transmitted based at least in part on a payment request from the second supernetwork instance.

6. The system of claim 1, wherein the first global transaction router further causes the computing device to at least:
determine that the first network hub has failed to transmit a status acknowledgement for the participant status; and
repropagate the participant status to the second network hub.

7. The system of claim 1, wherein the first global transaction router further causes the computing device to at least:
determine that the second supernetwork instance has failed to transmit a status acknowledgement for the participant status; and
repropagate the participant status to the second supernetwork instance.

8. A method, comprising:
transmitting, by a first global transaction router hosted by a first supernetwork instance, a query to a first network hub for a status of a participant system, the participant system being connected to the first network hub;
determining, by the first global transaction router hosted by the first supernetwork instance, a participant status for the participant system based at least in part on a query response from the first network hub;
updating, by the first global transaction router hosted by the first supernetwork instance, a participant status cache based at least in part on the participant status;
propagating, by the first global transaction router hosted by the first supernetwork instance, the participant status to a second network hub connected to the first supernetwork instance; and
propagating, by the first global transaction router hosted by the first supernetwork instance, the participant status to a second supernetwork instance connected to the first supernetwork instance.

9. The method of claim 8, wherein the participant status comprises a participant identifier for the participant system and a payment network status for the participant system.

10. The method of claim 9, wherein the participant identifier identifies the first supernetwork instance and the first network hub for routing a payment request to the participant system.

11. The method of claim 8, the participant status for the participant system is further determined based at least in part on a status threshold and a plurality of query responses from the first network hub, the plurality of query responses comprising the query response.

12. The method of claim 8, wherein the query for the first network hub is transmitted based at least in part on a payment request from the second supernetwork instance.

13. The method of claim 8, further comprising:
determining, by the first global transaction router hosted by the first supernetwork instance, that the first network hub has failed to transmit a status acknowledgement for the participant status; and
repropagating, by the first global transaction router hosted by the first supernetwork instance, the participant status to the second network hub.

14. The method of claim 8, further comprising:
determining, by the first global transaction router hosted by the first supernetwork instance that the second supernetwork instance has failed to transmit a status acknowledgement for the participant status; and
repropagating, by the first global transaction router hosted by the first supernetwork instance, the participant status to the second supernetwork instance.

15. A non-transitory, computer-readable medium, comprising a first global transaction router hosted by a first supernetwork instance, the first global transaction router comprising machine-readable instructions, when executed by a processor of a computing device, cause the computing device to at least:
transmit a query to a first network hub for a status of a participant system, the participant system being connected to the first network hub;
determine a participant status for the participant system based at least in part on a query response from the first network hub;
update a participant status cache based at least in part on the participant status;
propagate the participant status to a second network hub connected to the first supernetwork instance; and
propagate the participant status to a second supernetwork instance connected to the first supernetwork instance.

16. The non-transitory, computer-readable medium of claim 15, wherein the participant status comprises a participant identifier for the participant system and a payment network status for the participant system.

17. The non-transitory, computer-readable medium of claim 16, wherein the participant identifier identifies the first supernetwork instance and the first network hub for routing a payment request to the participant system.

18. The non-transitory, computer-readable medium of claim 15, wherein the participant status for the participant system is further determined based at least in part on a status threshold and a plurality of query responses from the first network hub, the plurality of query responses comprising the query response.

19. The non-transitory, computer-readable medium of claim 15, wherein the query for the first network hub is transmitted based at least in part on a payment request from the second supernetwork instance.

20. The non-transitory, computer-readable medium of claim 15, wherein the first global transaction router further causes the computing device to at least:
determine that the first network hub has failed to transmit a status acknowledgement for the participant status; and
repropagate the participant status to the second network hub.
